(19) United States
(12) Patent Application Publication
(10) Pub. No.: US 2016/0372111 A1
(43) Pub. Date: Dec. 22, 2016

(54) DIRECTING VOICE INPUT

(71) Applicant: Lenovo (Singapore) Pte. Ltd., Singapore (SG)

(72) Inventors: Russell Speight VanBlon, Raleigh, NC (US); Nathan J. Peterson, Durham, NC (US); Arnold S. Weksler, Raleigh, NC (US); Rod D. Waltermann, Rougemont, NC (US); John Carl Mese, Cary, NC (US)

(21) Appl. No.: 14/741,605

(22) Filed: Jun. 17, 2015

(51) Int. Cl. G10L 15/22

(52) U.S. Cl. CPC G10L 15/22; G10L 2015/226

(57) ABSTRACT

One embodiment provides a method, including: detecting, at an electronic device, input associated with mouth movement; associating, using a processor, the input with at least one of a plurality of available voice enabled applications; and directing, using a processor, the input to at least one voice enabled application. Other aspects are described and claimed.

### BACKGROUND

Information handling devices (e.g., tablets, smart phones, laptop computers, personal computers, etc., herein simply “electronic devices” or “devices”) may be provided with voice enabled applications such as a virtual assistant, which may respond to voice commands, or voice assisted applications, which may accept voice input as a mode of user interface. Voice inputs may be used to perform a wide variety of specified actions. Using voice input to direct the actions of these devices has become increasingly popular. However, when using voice input around others, in order to provide audio detectable by the speech recognition system, the voice input may be overheard. Limiting the ability of nearby people to hear user commands and other voice inputs can be difficult.

### BRIEF SUMMARY

In summary, one aspect provides a method, comprising: detecting, at an electronic device, input associated with mouth movement; associating, using a processor, the input with at least one of a plurality of available voice enabled applications; and directing, using a processor, the input to the at least one voice enabled application.

Another aspect provides an electronic device, comprising: an input device; a processor operatively coupled to the input device; a memory device that stores instructions executable by the processor to: detect, at the input device, input associated with mouth movement; associate, the input with at least one of a plurality of available voice enabled applications; and direct, the input device to the at least one voice enabled application.

A further aspect provides an apparatus, comprising: a first processor; a network adapter; storage bearing instructions executable by a second processor for: detecting input associated with mouth movement; associating the input with at least one of a plurality of available voice enabled applications; and directing the input to the at least one voice enabled application; wherein the first processor transfers the instructions over a network via the network adapter.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of electronic device circuitry.

FIG. 2 illustrates another example of electronic device circuitry.

FIG. 3 illustrates an example method of commanding a device to perform actions based on alternative types of vocal input.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Voice input can be used as an input for commanding a device to perform a variety of actions, e.g., commanding a media player to play a specified song, commanding a voice call application to call a designated contact, etc., or as a mode of providing substantive input to a voice-enabled application, e.g., transcribing dictation, providing directions to a navigation application, etc. However, when using voice input, anyone within earshot might hear what the user is saying. In certain instances, this could allow sensitive information to be overheard by others. For example, a user that wants to send a text message during a conference call or a meeting might not want to interrupt the meeting with the speech input into the text messaging application, might not want to have the other meeting participants to hear the contents of the message, etc.

In order to prevent others from overhearing the voice input, a user may provide touch-based input. However, this is slower than speaking and would require the user to both see and touch the screen, preventing the user from simultaneously completing other tasks. A user could also try to speak quietly to the device. While this may prevent others from hearing the voice input, it might also prevent the device from effectively detecting audio input and negatively impact its ability to recognize what the user is saying.

These technical issues present problems for users in that it may be difficult for them to provide effective, “hands-free,” commands to various devices without having their commands heard by other people. Conventional methods for preventing others from hearing user commands are slower and prevent the user from being able to multi-task. As such, a technical problem is found in that current solutions fail to provide users with an effective, hands-free, method of providing commands or other voice inputs to the device that cannot be heard or understood by others.

Accordingly, an embodiment provides a method of detecting and processing normal voice inputs and alternative vocal inputs differently. Using such alternate detection, an embodiment may direct the inputs differently, e.g., determine where the input gets routed, e.g., depending on the volume of speech, effectively creating multiple levels of volume processing. For example, silent or inaudible mouth movements might be routed to application A, whispering or barely audible inputs might be routed to application B, and in contrast normal, audible talking might be routed to application C, loud speaking might be routed to application D, and shouting input might be routed to application E. These “volume segments” could be configured by the user to include any combination of different speaking volumes. Speaking at an audible volume may be ignored, transcribed, recorded, or temporarily cached.

By way of example, if a speaker who is presenting to an audience wants to record a personal note, they could sub-vocally provide input such as “Write down [note],” which may be recorded and transcribed into a memo application without being audible to the audience. In an embodiment that temporarily caches audio, the speaker may also sub-vocally provide input such as “Write that down,” and have the device transcribe the last comment audibly communicated by an audience member, which was passively recorded and temporarily cached by the device.

The illustrated example embodiments will be best understood by reference to the figures. The following description is intended only by way of example, and simply illustrates certain example embodiments.

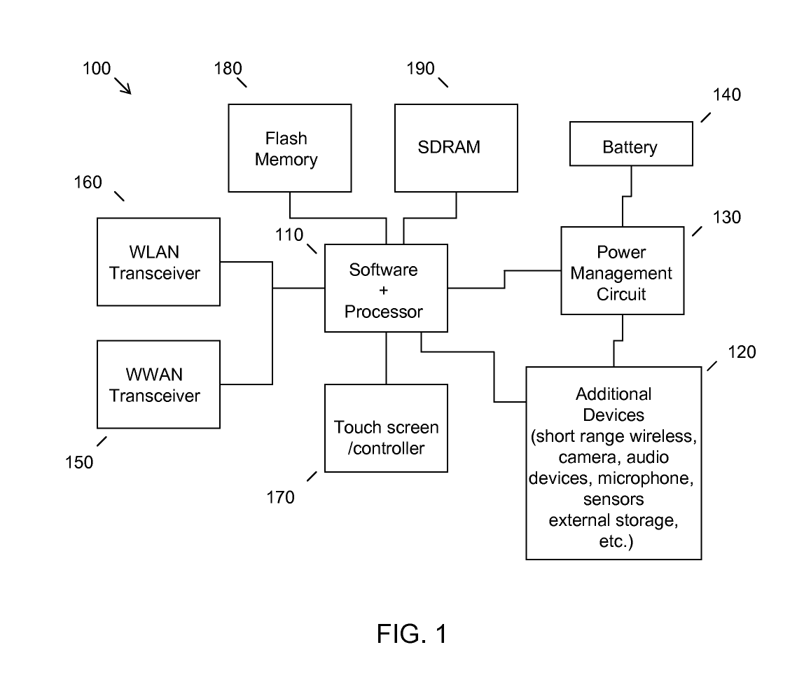

While various other circuits, circuitry or components may be utilized in electronic devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included, e.g., an image sensor such as a camera, a microphone for receiving voice input, and other sensor(s) or interfaces for connected sensors. For example, devices 120 may include electromyography (EMG) sensors or interfaces therefor, as further described herein. System 100 often includes a touch screen 170 for data input and display/rendering. System 100 also typically includes various memory devices, for example flash memory 180 and SDRAM 190.

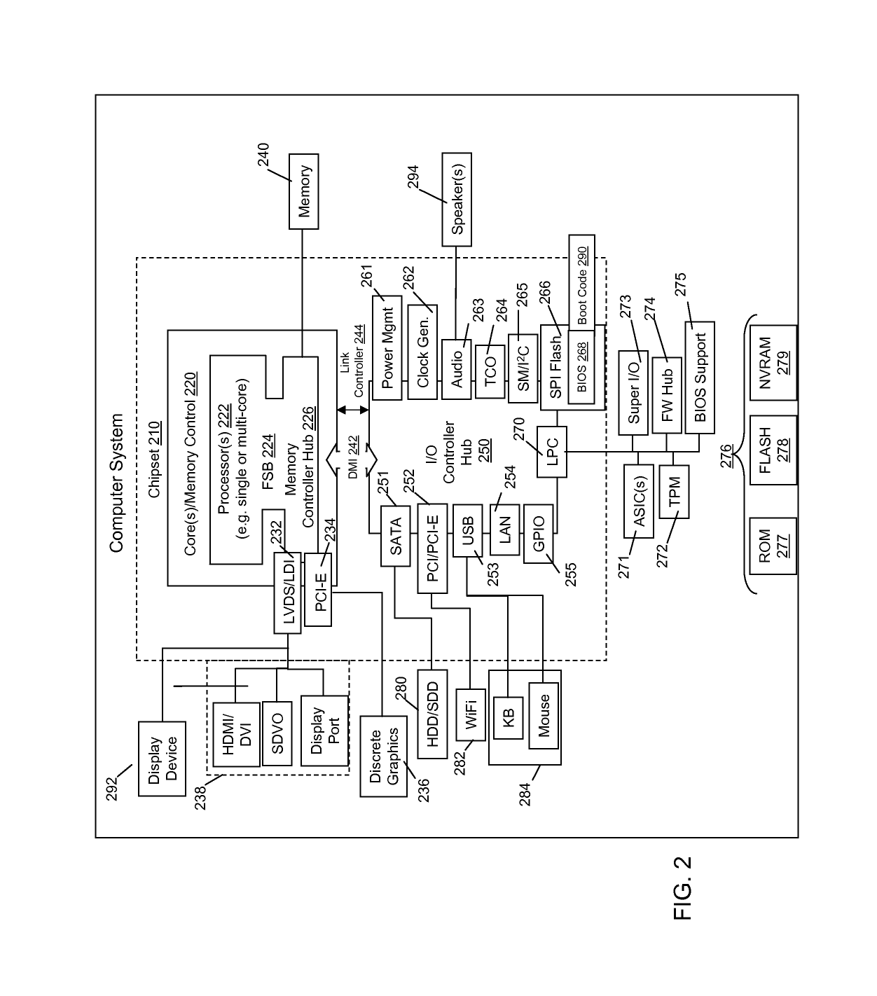

FIG. 2 depicts a block diagram of another example of electronic device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, sensors, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Electronic device circuitry, as for example outlined in FIG. 1 or FIG. 2, may be used in devices such as tablets, smart watches or other wearable devices, smart phones, personal computer devices generally, and/or electronic devices which users may provide voice or other inputs. For example, the circuitry outlined in FIG. 1 may be implemented in a tablet or smart phone embodiment, whereas the circuitry outlined in FIG. 2 may be implemented in a personal computer embodiment.

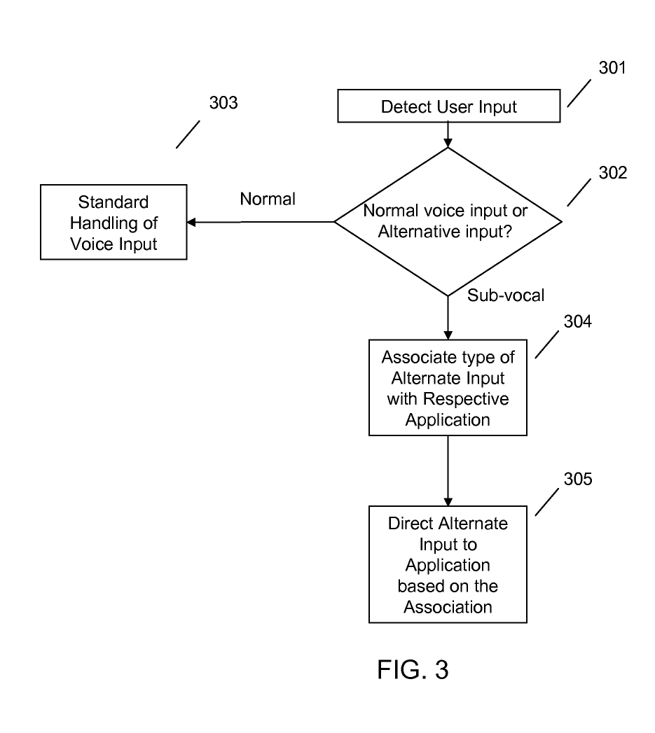

Referring now to FIG. 3, at 301, an embodiment may detect input data from a user. The input data can be either normal voice input (e.g., audible to or detectable by a microphone of the device and resolvable by the speech recognition system) or a type of alternative input (e.g., sub-vocal input such as silently mouthed words detectable by a camera, EMG sensors or the like). Normal or standard voice input includes voice input communicated to the device at a standard speaking volume. Alternative input includes altered volume voice input (e.g., higher or lower amplitude voice inputs), as well as sub-vocal input. Sub vocal input includes, to name a few, include throat muscle movements, inaudible mouth movements, and whispers that are not detectable by the microphone or useable by a speech recognition engine. Alternative input may also include louder speaking and shouting. Detecting normal voice input may be accomplished by using a microphone. Detecting types of alternative input can be accomplished by using a microphone or via use of a variety of different input devices and methods. For example, silently mouthed words may be detected by EMG sensors, cameras or other optical sensors, or combinations of the foregoing. Other methods for obtaining the user input are possible and contemplated.

Once an embodiment detects some type of user input at 301, an embodiment may differentiate between the types of user input at 302. For example, if a device recognizes that the input data corresponds to normal amplitude voice input, then the device may transcribe it, act on it (e.g., if it is a predetermined voice command), temporarily cache it, e.g., based on application(s) running or the settings implemented by the user at 303.

However, an embodiment provides additional processing in order to distinguish between types of voice inputs (e.g., soft voice inputs, loudly spoken voice inputs) as well as in an effort to identify sub-vocal inputs, e.g., detected using an alternative input device. For example, an embodiment may, at 302, determine that a sub-vocal input, e.g., silently mouthed words detected via camera and/or EMG sensor, has been detected at 302. An embodiment may therefore associate a specific application with this type of alternative input. For example, a sub-vocal input such as a silent mouth movement can be routed to application A, which handles all device functions related to silent mouth movements, whereas a normal volume voice input may be routed to application B, which handles all device functions related to normal voice inputs. Likewise, an embodiment may differentially route, direct or target various audio segments (e.g., based on amplitude, input device that detects the input, etc.) to different applications or tasks.

Returning to the example of FIG. 3, after associating a type of alternative input with an application, an embodiment may, at 305, route or provide the input to a different application, e.g., to perform a different underlying task of the application based upon the association. For example, using the example of FIG. 3, a user may be talking on the phone, with the normal volume voice input being routed to the voice application for the voice call, and sub-vocally mouth the words, e.g., through the use of silent mouth movements, “Text wife I will be home late.” An embodiment may differentiate, at 302, these types of inputs such that the use of silent mouth movements triggers directing of the words identified as being associated with the silent mouth movements to application A, e.g., a text messaging application, to control the texting of the desired phrase rather than routing this input to the voice application running on the device.

The various embodiments described herein thus represent a technical improvement to current methods of handling different types of voice inputs and even handling of sub-vocal inputs. Using the techniques described herein, a user can effectively direct voice inputs and sub-vocal inputs to an electronic device, e.g., by using an alternative form of input, such as sub-vocal input, that is now distinguishable by the electronic device. This assists in appropriately directing of inputs to various applications and tasks that are available on the electronic device, as well as improves the electronic device in terms of privacy, e.g., a user may prevent other people nearby from listening to the user's voice inputs. Additionally, the system as described herein allows the user to more effectively multi-task because the user does not need to be dedicated to voice, gesture or touch input, or combination thereof, to complete a certain action. Rather, new input routing or direction is enabled, e.g., sub-vocal inputs may be appropriately directed to applications (e.g., voice enabled applications) that typically do not differentially handle sub-vocal inputs but rather treat them as standard or normal voice inputs.

An embodiment may include a technique of providing a program or application as a download over a network. For example, an embodiment may be provided as an apparatus, having a first processor, a network adapter; and storage bearing instructions executable by a second processor, e.g., a client device. The apparatus may include in the storage instructions executable by the second processor for detecting input associated with mouth movement, associating the input with at least one of a plurality of available voice enabled applications, and directing the input to the at least one voice enabled application; where the first processor of the apparatus transfers the instructions over a network via the network adapter, e.g., to a client device having the second processor.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, at an electronic device, input associated with mouth movement;
associating, using a processor, the input with at least one of a plurality of available voice enabled applications; and
directing, using a processor, the input to at least one voice enabled application.

2. The method of claim 1, wherein the input comprises a sub-vocal input.

3. The method of claim 2, wherein the sub-vocal input is inaudible.

4. The method of claim 1, wherein the detecting comprises detecting input with an input device selected from the group consisting of a microphone, a camera and an electromyography sensor.

5. The method of claim 4, wherein the associating includes associating the input with the input device.

6. The method of claim 1, further comprising identifying, in the input, one or more words.

7. The method of claim 6, wherein the identifying comprises applying a processing technique selected from the group consisting of gesture recognition and electromyography.

8. The method of claim 1, wherein the associating comprises associating audible input of the input with an amplitude profile;
wherein the directing the input to at least one voice enabled application comprises directing the input based on the amplitude profile.

9. The method of claim 8, further comprising offering an interface to adjust assignment of one or more amplitude profiles with different speaking volumes.

10. The method of claim 1, wherein the plurality of voice enabled applications are running on the electronic device at the same time.

11. An electronic device, comprising:
an input device;
a processor operatively coupled to the input device;
a memory device that stores instructions executable by the processor to:
detect, at the input device, input associated with mouth movement;
associate the input with at least one of a plurality of available voice enabled applications; and
direct the input to at least one voice enabled application.

12. The electronic device of claim 11, wherein the input comprises a sub-vocal input.

13. The electronic device of claim 12, wherein the sub-vocal input is inaudible.

14. The electronic device of claim 11, wherein to detect comprises detecting input with an input device selected from the group consisting of a microphone, a camera, and an electromyography sensor.

15. The electronic device of claim 14, wherein to associate includes associating the input with the input device.

16. The electronic device of claim 11, wherein the instructions are executable by the processor to identify, in the input, one or more words.

17. The electronic device of claim 16, wherein to identify comprises applying a processing technique selected from the group consisting of gesture recognition and electromyography.

18. The electronic device of claim 11, wherein the instructions are executable by the processor to associate the audible input of the input with an amplitude profile;
wherein to direct the input to at least one voice enabled application comprises directing the input based on the amplitude profile.

19. The electronic device of claim 18, further comprising a user interface, wherein the instructions are further executable by the processor to offer within the user interface an assignment adjustment for one or more amplitude profiles and different speaking volumes.

20. An apparatus, comprising:
a first processor;
a network adapter; and
storage bearing instructions executable by a second processor for:
detecting input associated with mouth movement;
associating the input with at least one of a plurality of available voice enabled applications; and
directing the input to the at least one voice enabled application;
wherein the first processor transfers the instructions over a network via the network adapter.
